(19) United States
(12) Patent Application Publication
(10) Pub. No.: US 2002/0104946 A1
(43) Pub. Date: Aug. 8, 2002

(54) Structure for holding a towel rack and the like

(76) Inventor: Ming-Hsiao Lai, Chang-Hua Hsien (TW)

Correspondence Address: HARRISON & EGBERT, 412 MAIN STREET, 7TH FLOOR, HOUSTON, TX, 77002, US

(21) Appl. No.: 09/773,472

(22) Filed: Feb. 2, 2001

(51) Int. Cl. A47K 1/00; F16L 3/08

(52) U.S. Cl. 248/316.8; 248/224.7; 248/251

(57) ABSTRACT

A structure comprising two holding members for retaining a towel rail and the like. The holding members are formed of a base, a disk, a decorative cover, and a head. The base is fastened onto a wall. The head is provided with a hole for retaining the towel rail. The disk and the decorative cover are securely retained between the base and the head.

### BACKGROUND OF THE INVENTION

1. Field of the Invention

The present invention relates generally to a towel rack, and more particularly to a structure for holding the towel rack.

2. Description of Related Art

As shown in FIGS. 1-3, a prior art structure is designed to hold a towel rack 1 and is formed of two cup-shaped members 10 which are fastened onto a bathroom wall. The cup-shaped members 10 are formed of a base 11, a decorative cover 12, a decorative shell 13, and a head 14. The base 11 is fastened to the bathroom wall and is provided at the center with a rod 111 extending in the direction away from the wall for locating the cover 12, the shell 13 and the head 14. The head 14 is provided with a bolt 15, which is fastened into the head 14 such that the tail end of the bolt 15 presses against the free end of the rod 111.

The prior art structure is defective in design in that it is time-consuming to assemble the structure, and that it is devoid of means to connect the base 11, the cover 12, the shell 13, which are therefore apt to fall apart. As a result, the towel rack 1 can not be securely held on the wall by the two cup-shaped members 10 of the prior art structure.

### BRIEF SUMMARY OF THE INVENTION

The primary objective of the present invention is to provide a structure capable of holding a towel rack securely on the wall.

The structure of the present invention comprises two holding members which are identical in construction and are formed of a base, a dusk, a decorative cover, and a head. The base, the disk, the decorative cover, and the head are provided with retaining means to enhance he structural integrity of the holding members.

The features and the advantages of the present invention will be readily understood upon a thoughtful deliberation of the following detailed description of the present invention with reference to the accompanying drawings.

### BRIEF DESCIPTION OF THE SEVERAL VIEWS OF THE DRAWINGS

FIG. 1 shows a perspective view of a prior art structure.

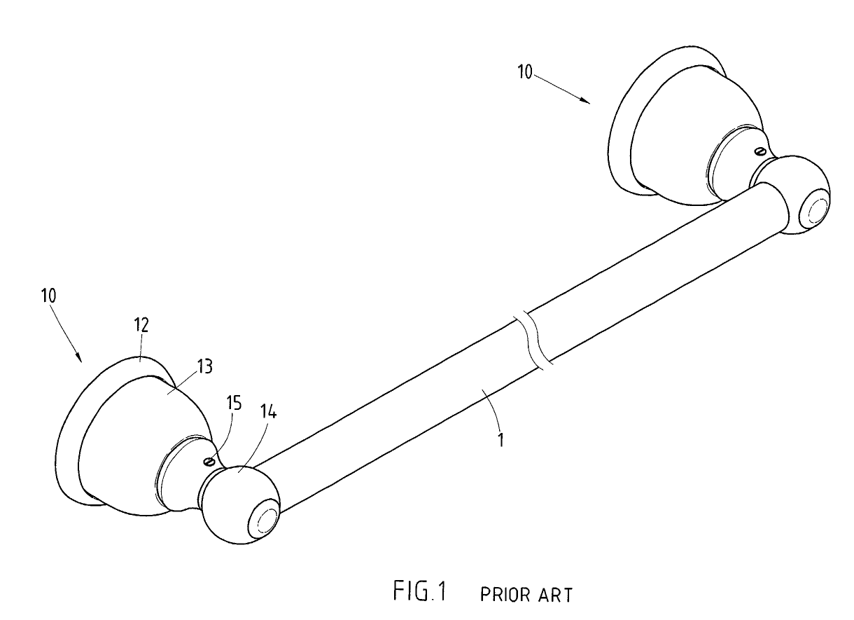

FIG. 2 shows an exploded view of a cup-shaped member of the prior art structure.

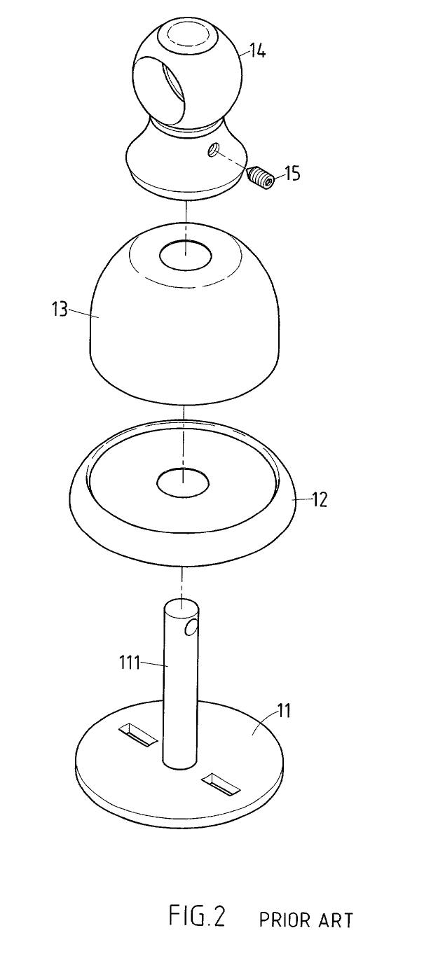

FIG. 3 shows a sectional view of the cup-shaped member of the prior art structure in combination.

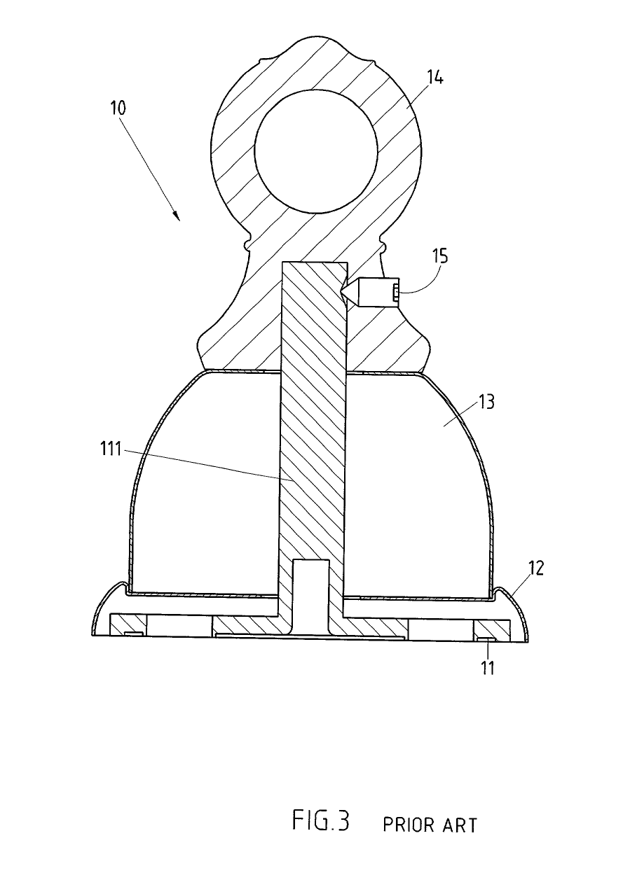

FIG. 4 shows an exploded view of a holding member of the structure of the present invention.

FIG. 5 shows a sectional view of the holding member of the structure of the present invention in combination.

### DETAILED DESCRIPTION OF THE INVENTION

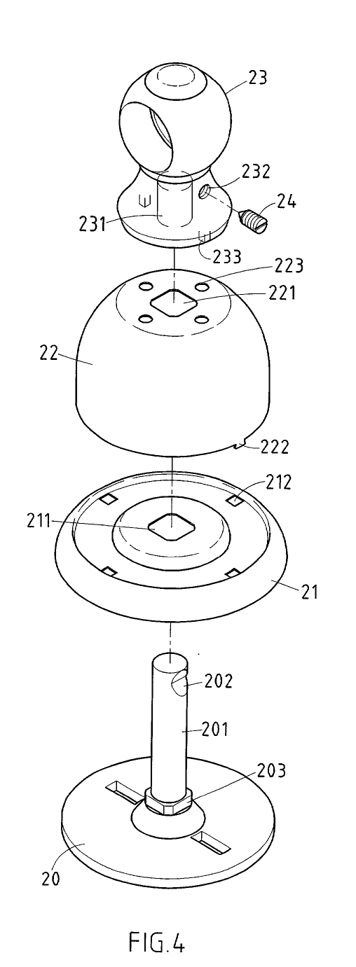

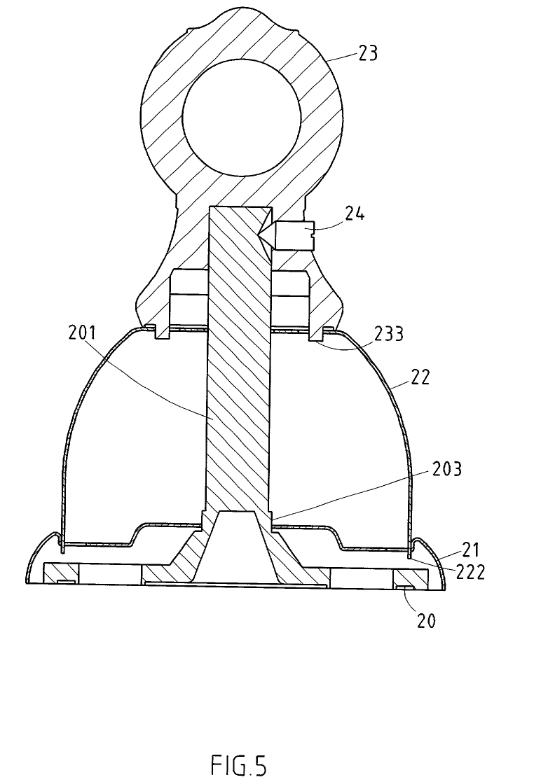

As shown in FIGS. 4 and 5, a structure embodied in the present invention is intended to hold a towel rail and the like and is formed of two holding members which are identical in construction. Each holding member comprises a base 20, a disk 21, a decorative cover 22, and a head 23.

The base 20 is fastened onto a bathroom wall and is provided in the center with a locating rod 201 of a predetermined length and extending uprightly therefrom in the direction away from the bathroom wall. The locating rod 201 is provided at the base portion thereof with a polygonal protrusion 203, and at the free end thereof with a notch 202.

The disk 21 is provided in the center thereof with a polygonal through hole 211, and in the outer side thereof with a plurality of retaining slots 212. The disk 21 is joined with the base 20 such that the polygonal through hole 211 of the disk 21 is securely fitted over the polygonal protrusion 203 of the base 20.

The decorative cover 22 is of a cup-shaped construction and is provided along the brim thereof with a plurality of retaining projections 222 corresponding in location to the retaining slots 212 of the disk 21. The cover 22 is provided at the center of the bowl bottom thereof with a polygonal through hole 221. The cover 22 is further provided in the bowl bottom with a plurality of retaining through holes 223. The cover 22 is joined with the disk 21 and the base 20 such that the retaining projections 222 are retained in the retaining slots 212 of the disk 21, and that the polygonal through hole 221 is securely fitted over the polygonal protrusion 203 of the base 20.

The head 23 is provided in the outer end with a rail holding hold, and in the inner end with a retaining blind hole 231 dimensioned to receive therein the free end of the locating rod 201 of the base 20. The head 23 is further provided on the inner end with a plurality of retaining projections 233 corresponding in location to the retaining through holes 223 of the decorative cover 22. The head 23 is further provided in the cover wall of the midsegment thereof with a threaded hole 232 in communication with the retaining blind hole 231 of the head 23. The head 23 is joined with the decorative cover 22 and the base 20 such that the retaining projections 233 of the head 23 are retained in the retaining through holes 223 of the cover 22, and that the free end of the locating rod 201 of the base 20 is inserted into the retaining blind hole 231 of the head 23, and further that the notch 202 of the free end of the locating rod 201 is pressed against by a bolt 24 via the threaded hole 232 of the head 23. The bolt 24 is engageable with the threaded hole 232.

The embodiment of the present invention described above is to be regarded in all respects as being merely illustrative and not restrictive. Accordingly, the present invention may be embodied in other specific forms without deviating from the spirit thereof. The present invention is therefore to be limited only by the scope of the following appended claim.

I claim:

1. A structure for holding a towel rail and the like, said structure comprising two holding members identical in construction to each other, wherein said holding members comprise:
a base fastened onto a wall and provided in a center thereof with a locating rod extending uprightly therefrom in the direction away from the wall, said locating rod being provided at a base portion thereof with a polygonal protrusion, and at a free end thereof with a notch;
a disk provided in a center thereof with a polygonal through hole, and in an outer thereof with a plurality of retaining slots whereby said disk is joined with said base such that said polygonal through hole of said disk is fitted over said polygonal protrusion of said base;
a decorative cover of a cup-shaped construction and provided in a brim thereof with a plurality of retaining projections corresponding in location to said retaining slots of said disk, said decorative cover being further provided at the center of a bowl bottom thereof with a polygonal through hole, and in the bowl bottom thereof with a plurality of retaining through holes whereby said decorative cover is joined with said disk and said base in such a manner that said retaining projections of said decorative cover are retained in said retaining slots of said disk, and that said polygonal through hole of said decorative cover is fitted over said polygonal protrusion of said locating rod of said base; and
a head provided in an outer end with a rail holding hole, and in an inner end with a retaining blind hole dimensioned to receive therein the free end of said locating rod of said base, said head further provided on the inner end thereof with a plurality of retaining projections corresponding in location to said retaining through holes of said decorative cover, said head further provided in the outer wall of a midsegment thereof with a threaded hole and a bolt engageable with said threaded hole, said threaded hole being in communication with said retaining blind hole of said head whereby said head is joined with said decorative cover and said base such that said retaining projections of said head are retained in said retaining through holes of said decorative cover, and that the free end of said locating rod of said base is inserted into said retaining blind hole of said head, and further that said notch of the free end of said locating rod of said base is pressed against by said bolt via said threaded hole of said head.
